(19) United States
(12) Patent Application Publication
(10) Pub. No.: US 2014/0292526 A1
(43) Pub. Date: Oct. 2, 2014

(54) MOBILE DEVICE ARRANGED WITH A SAFETY APPLICATION AND METHOD FOR INITIATING AN ALARM FOR USE IN THE DEVICE

(71) Applicant: XH MOBILE SOLUTIONS AB, Lomma (SE)

(72) Inventors: Gustaf Hansson, Lund (SE); Mijo Balic, Malmo (SE); Jan Westström, Bjarred (SE)

(73) Assignee: XH MOBILE SOLUTIONS AB, Lomma (SE)

(21) Appl. No.: 14/353,946

(22) PCT Filed: Oct. 25, 2012
(86) PCT No.: PCT/SE2012/051153

§ 371 Date: Apr. 24, 2014

Related U.S. Application Data
(60) Provisional application No. 61/551,005, filed on Oct. 25, 2011.

(30) Foreign Application Priority Data
Oct. 25, 2011 (SE) 1150986-6

(51) Int. Cl. G08B 21/18

(52) U.S. Cl. CPC G08B 21/18
USPC 340/687

(57) ABSTRACT

A mobile device has a memory, a socket and a controller. The socket is configured to receive a plug, and the controller is configured to detect that a plug is received in the socket; determine that a start point has been reached and in response thereto activate a safety application; and detect that the plug is removed from the socket, and, in response thereto, cause the safety application to activate an alarm.

### TECHNICAL FIELD

This application relates to a method and an apparatus for improved security and safety, and in particular to a mobile device and associated method for initiating an alarm.

### BACKGROUND

In today's society personal security and safety is of growing importance. There is thus a need for efficient safety devices for personal safety and protection. Today, there are a number of such devices available to the general public. Nevertheless, people are generally feeling more insecure than before.

For instance, the U.S. Pat. No. 3,851,326 discloses an alarm device is provided to inhibit purse snatching. A battery-operated sound emitting device is provided for placement in the purse and secured thereto as by a pin. A flexible cord is connected at one end to the device and the other end forms into a wrist strap looped about the wearer's wrist. The cord includes a separable jack connection forming part of an arming circuit. The device is actuated if the bag is snatched and the jack connections broken in the cord. The alarm device cannot be turned off except by re-connecting the jack and actuating a relatively inaccessible reset switch. This device suffers from that if the device is carried deep in the purse the sound that is emitted is muffled by the purse and its content which renders the alarm device inefficient.

The U.S. Pat. No. 5,374,919 discloses a method and apparatus are provided for carrying and accessing multiple safety devices, wherein the removal of one safety device simultaneously activates a second safety device. The method includes removing a chemical spray canister secured to a pack body, wherein an activation cord pulls an alarm pin thereby activating an audible alarm. The apparatus includes a spray canister and an audible alarm attached to a pack body, the canister and alarm being concealed by a cover. The cover is attached to the pack body with multiple slide fasteners. The cover has attached thereto a rip cord, so that when the rip cord is pulled by the user, the cover is partially or completely removed to expose the spray canister and the alarm; the spray canister and the alarm are interconnected by a cord so that removal of the spray canister simultaneously activates the audible alarm. This safety device suffers from the same drawbacks as U.S. Pat. No. 3,851,326.

The British patent GB2467204 discloses a system comprising a phone and a distress alarm, whereby there is a direct mechanical connection between the alarm and the phone. The separation of the alarm from the phone will trigger activation of the alarm. When the alarm and the phone are connected, the alarm is deactivated. The alarm output is generated at the alarm. A switch device or sensor detects when the alarm has become separated from the phone and activates the alarm. The circuit inside the alarm connects causing the alarm to sound. The alarm may be connected by a plug-in mechanism, a hinge mechanism, and/or a sliding-mechanism, to the outside, or inside of the phone. The alarm may be connected to a compartment connected to the outside or inside of the phone via similar mechanisms. The system may further be arranged to transmit video and/or audio in real-time when the alarm is separated from the phone. The system may additionally comprise a GPS means for position determination whereby in response to separation of the alarm from the phone, the current position is transmitted to a chosen recipient.

This system requires that the user actively activates the alarm by inserting it and also that the user is aware of the location of the alarm at all times so that the alarm is not lost and may be activated quickly. Furthermore the system requires two modules having built-in intelligence and separate power sources, both the alarm and the phone, thereby adding to the complexity and cost of the system.

In order to ensure that the alarm sound is perceived by a potential rescuer the alarm devices of the prior art would have to be modified to emit a louder alarm tone. This could, however, lead to a sound level that could be harmful should the alarm be activated when the device is not muffled.

There is thus a need for a personal safety device that is easy to activate while still being able to ensure that a potential rescuer or aider is notified and made aware of the alarm situation.

### SUMMARY

It is an object of the teachings of this application to overcome the problems listed above by providing a mobile device comprising a memory, a socket and a controller, wherein said socket is configured to receive a safety plug, and wherein said controller is configured to detect that a plug is received in the socket, determine that a start point has been reached and in response thereto activate a safety application, and wherein said controller is configured to detect that said plug is removed from the socket, and, in response thereto, cause said safety application to activate an alarm.

This has the benefit of enabling a user to automatically set up areas of particular risk and to ensure that alarm functionality, as provided by the safety application, is available during certain times and/or in certain areas. This enables the user to trust that the mobile device will activate and possibly arm the alarm functionality at times or locations that are of particular risk.

Furthermore the use of a simple safety plug simplifies the safety arrangement greatly as a safety plug may be implemented very cheaply, as will be disclosed herein.

It is also an object of the teachings of this application to overcome the problems listed above by providing a safety plug comprising an identification module, wherein said safety plug is arranged to co-operate with a mobile device according to herein.

It is also an object of the teachings of this application to overcome the problems listed above by providing a safety arrangement comprising a mobile device according to herein and a safety plug according to herein.

It is also an object of the teachings of this application to overcome the problems listed above by providing a method for activating an alarm for use in a mobile device, said method comprising detecting that a plug is received in the socket, determining that a start point has been reached and in response thereto activating a safety application, detecting that said plug is removed from the socket, and, in response thereto, causing said safety application to activate an alarm.

The inventors of the present invention have realized, after inventive and insightful reasoning, that by taking advantage of a mobile communication device's, such as a mobile phone's, effective means of communication, a safety device can easily and simply be achieved that is able to send an alarm notification to one or several chosen potential rescuers or aiders.

The inventors of the teachings of this application have realized after thoughtful and insightful reasoning that a superior safety arrangement is achieved by combining a mobile device with a safety plug arranged to co-operate with a socket, preferably an audio socket, in the mobile device in that a safety device that is capable of being easily activated and also deactivated and which has the capability of contacting one or several contacts and in a number of manners (which is adaptable to the contact's preferences) is provided without requiring structural modification to an existing mobile device. A safety application can simply be downloaded into the phone and the phone is then ready to act as a safety device in co-operation with said safety plug.

Another problem that lies with many of the prior art systems is that in some situations a user may not want the alarm to be active, but will then not have any place to store the plug which may get lost, as the alarm is armed all the time the pin is inserted.

It is another object of the teachings of this application to overcome the problems listed above by providing a mobile device comprising a memory, a socket and a controller, wherein said socket is configured to receive a safety plug, and wherein said controller is configured to detect that a plug is received in the socket, receive an execute command, activate a safety application, and detect that a plug is removed from the socket, and, in response thereto, activate an alarm.

It is also an object of the teachings of this application to overcome the problems listed above by providing a method for activating an alarm for use in a mobile device, said method comprising detecting that a plug is received in the socket, receiving an execute command, activating a safety application, and detecting that a plug is removed from the socket, and, in response thereto, activating an alarm.

This is beneficial in that the risk of losing the safety plug is greatly reduced and the user does not have to remember where the safety plug is stored.

It is also an object of the teachings of this application to overcome the problems listed above by providing a computer readable storage medium encoded with instructions that, when executed on a processor, perform the method according to herein.

The teachings herein find use in personal safety devices and system. Other environments, where the teachings herein are beneficial, are door safety and surveillance systems.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

The invention will be described in further detail under reference to the accompanying drawings in which:

FIGS. 1a and b each shows a schematic view of a safety device arrangement according to one embodiment of the teachings of this application;

FIG. 2 shows a schematic view of the general structure of a safety device according to one embodiment of the teachings of this application;

FIG. 3 shows a schematic state diagram for a function of a safety device according to one embodiment of the teachings of this application;

FIG. 4 shows a flowchart for a method according to one embodiment of the teachings of this application;

FIG. 5 shows a schematic view of a safety application according to one embodiment of the teachings of this application;

FIGS. 6a-d show schematic views of a mobile device according to embodiments of the teachings of this application; and

FIGS. 7a-e show schematic views of a safety plug according to embodiments of the teachings of this application.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

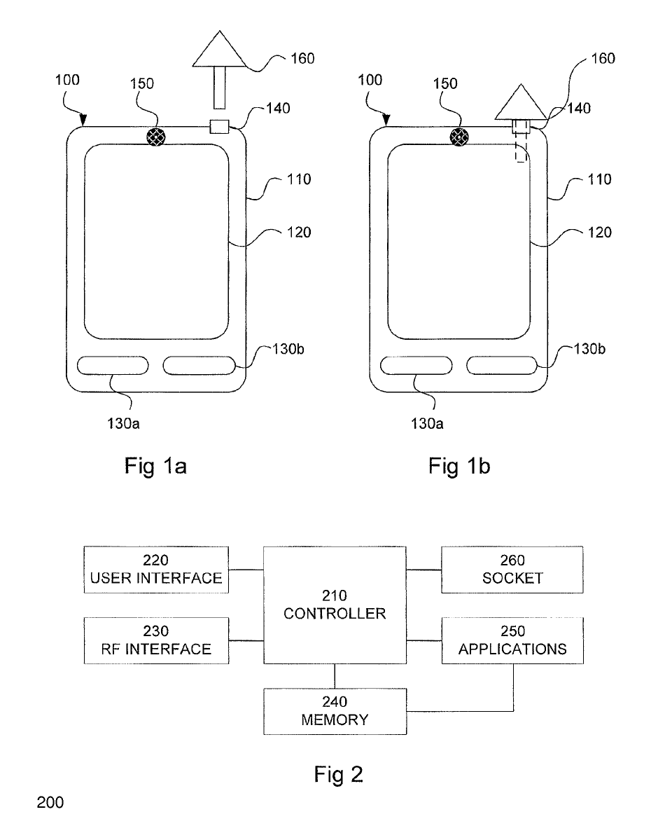

FIG. 1 shows a schematic overview of a mobile communications device 100 adapted according to the teachings herein. In the embodiment shown the mobile communications device is a mobile phone 100. In other embodiments the mobile communications device 100 is a personal digital assistant, a media player, a location finding device or any hand-held device capable of communicating with other devices. The mobile phone 100 comprises a housing 110 in which a display 120 is arranged. In one embodiment the display 120 is a touch display. In other embodiments the display 120 is a non-touch display. Furthermore, the mobile phone 100 comprises two keys 130a, 130b. In this embodiment the there are two keys 130, but any number of keys are possible and depends on the design of the mobile phone 100. In one embodiment the mobile phone 100 is configured to display and operate a virtual key on the touch display 120. It should be noted that the number of virtual keys are dependant on the design of the mobile phone 100 and an application that is executed on the mobile phone 100.

FIG. 2 shows a schematic view of the general structure of a device according to FIG. 1. The mobile phone 200 comprises a controller 210. The controller 210 may be implemented using instructions that enable hardware functionality, for example, by using executable computer program instructions in a general-purpose or special-purpose processor that may be stored on a computer readable storage medium (disk, memory etc) 240 to be executed by such a processor. The controller 210 is configured to read instructions from the memory 240 and execute these instructions to control the operation of the mobile device 200. The memory may be implemented using any commonly known technology for computer-readable memories such as ROM, RAM, SRAM, DRAM, CMOS, FLASH, DDR, SDRAM or some other memory technology. The mobile device 200 further comprises one or more applications 250. The applications are set of instructions that when executed by the controller 210 control the operation of the mobile device 200. The applications 250 may be stored on the memory 240. Examples of applications 250 are voice call applications, Short Message Service applications, and location finding applications. Alternatively, the mobile device 200 comprises a position finding apparatus such as a Global Positioning System (GPS) device which may be operably executed by the position finding application.

The mobile device 200 further comprises a user interface 220, which in the mobile device of FIG. 1 is comprised of the display 120, the keys 130, and a loudspeaker 150.

The mobile device 200 further comprises a radio frequency interface 230, which is adapted to allow the mobile device to communicate with other devices through a radio frequency band through the use of different radio frequency technologies. Examples of such technologies are W-CDMA, GSM, UTRAN, LTE, NMT to name a few. The controller 210 is configured to operably execute applications 250 such as the voice call and SMS applications through the RF interface 230.

The mobile devices 100, 200 also comprise a socket 140, 260 for receiving a plug. In a preferred embodiment the socket is an earplug socket 140. In one embodiment the socket 140 is a TRS (Tip, Ring, Sleeve) socket, A TR (Tip, Ring) socket or a TRRS (Tip, Ring, Ring, Sleeve) socket commonly used for audio plugs.

The socket 140 is arranged to receive a plug 160. The plug is separate from the mobile device 100 in one embodiment. In one embodiment the plug is shaped as a TRS (Tip, Ring, Sleeve) connector, A TR (Tip, Ring) connector or a TRRS (Tip, Ring, Ring, Sleeve) connector commonly used for audio plugs.

The inventors have realized that by shaping a safety plug 160 as a commonly found audio plug, beneficial use of mobile phones can be made without modifying the structure of the mobile phone or to require additional modules, thereby incorporating a safety plug 160 into the mobile device 100 easily.

In FIG. 1a the safety plug 160 is not connected to the mobile device 100, whereas in FIG. 1b the safety plug 160 has been inserted into the device 100 through the socket 140.

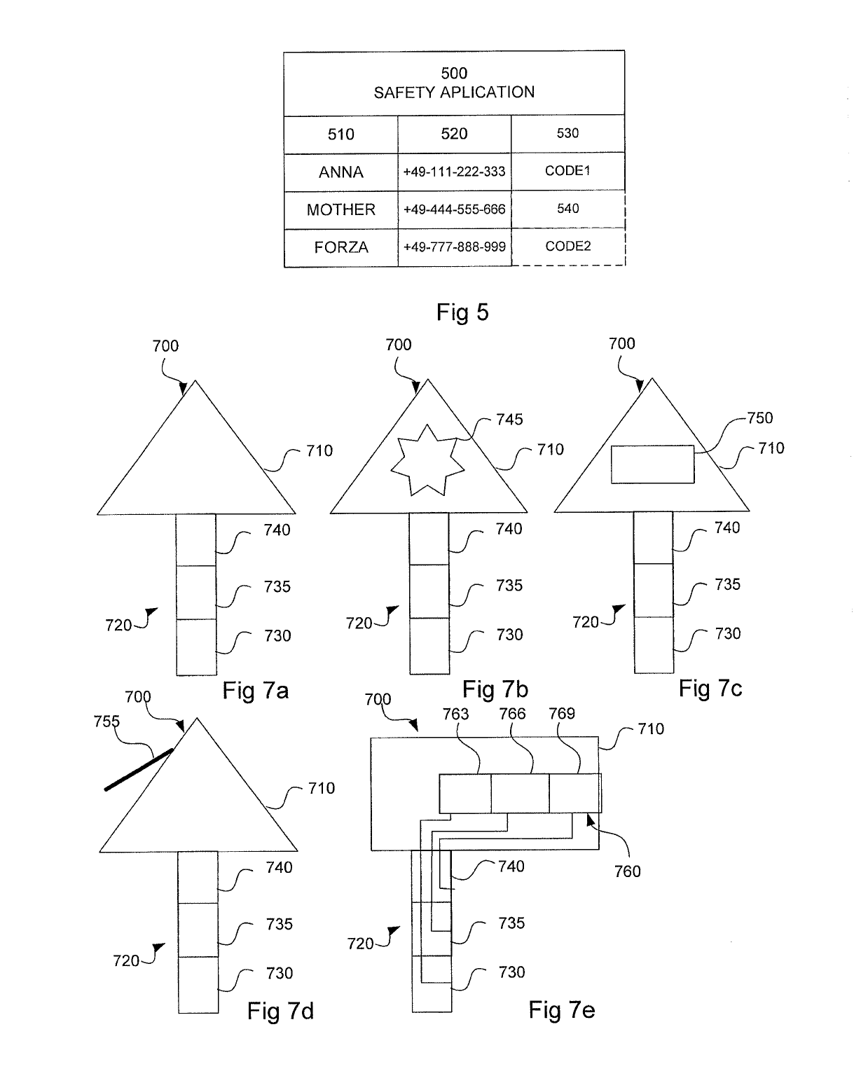

The mobile device is arranged with a safety application, which may be one of the applications 250. The safety application is shown in more detail at 500 in FIG. 5. When executed by the controller 210, the safety application causes the device to initiate an alarm when it is detected that the safety plug 160 is removed or extracted from the socket 140. The functionality of such a safety application will be discussed below in detail through exemplary embodiments.

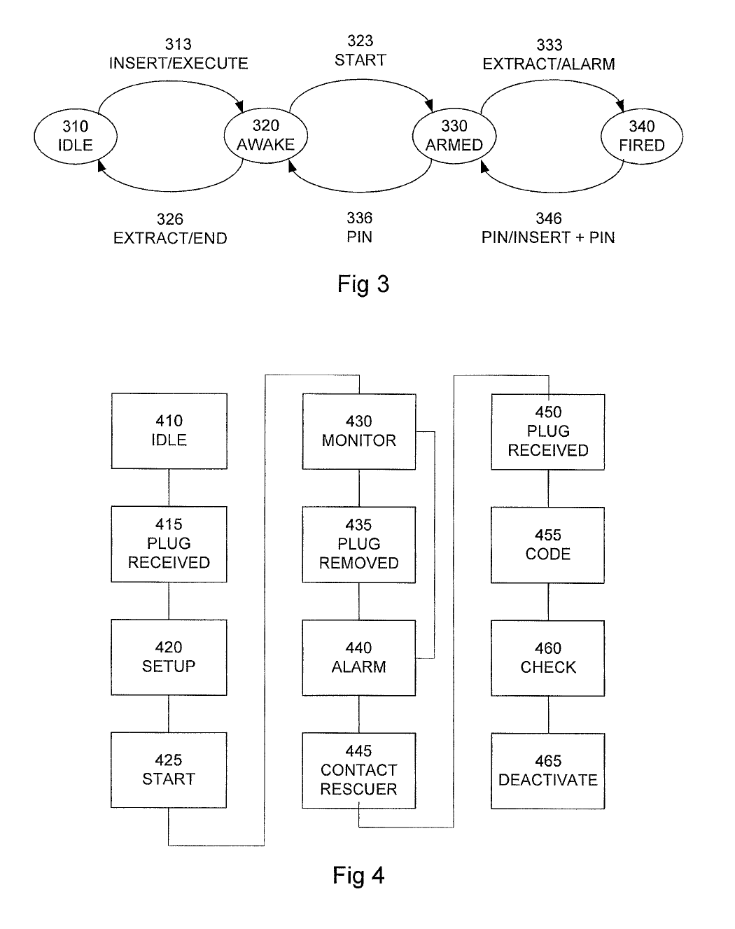

FIG. 3 is a state diagram showing the functionality of the safety application according to the teachings herein. FIG. 4 is a series of flow charts illustrating a method according to the teachings herein. FIG. 5 shows a schematic view of the components of the safety application.

In one embodiment, the safety application 500 is configured to keep a register of contact details 520 for a number of potential rescuers or aiders 510. Such potential rescuers may be a person or a service, such as a security firm. In the example of FIG. 5 the contact is a friend called “Anna”, the user's mother and a security company called “FORZA”. It should be noted that the number of potential rescuers or aiders is flexible and depends on a combination of design criteria and user wishes. The potential rescuers or aiders will hereafter be referred to as rescuers.

The controller 210 of the mobile device 100 is configured to receive data pertaining to such contacts and store them in the memory 240 where it is available to the safety application 500.

The controller 210 of the mobile device 100 is further configured to run or keep the safety application 500 in an idle mode while the mobile device 100 is turned on 410, see FIG. 4. This represents the IDLE state 310 in FIG. 3.

The controller 210 of the mobile device 100 is further configured to detect that a safety plug 160 is received 415 by the socket 140 and in response thereto activate the safety application 500. This detection initiates a state transition 313 to the state 320 AWAKE in FIG. 3.

In an alternative or additional embodiment the controller 210 of the mobile device 100 is further configured to receive an EXECUTE command, detect that a safety plug 160 is received in the socket and in response thereto activate the safety application 500 as indicated by the transition 313 in FIG. 3.

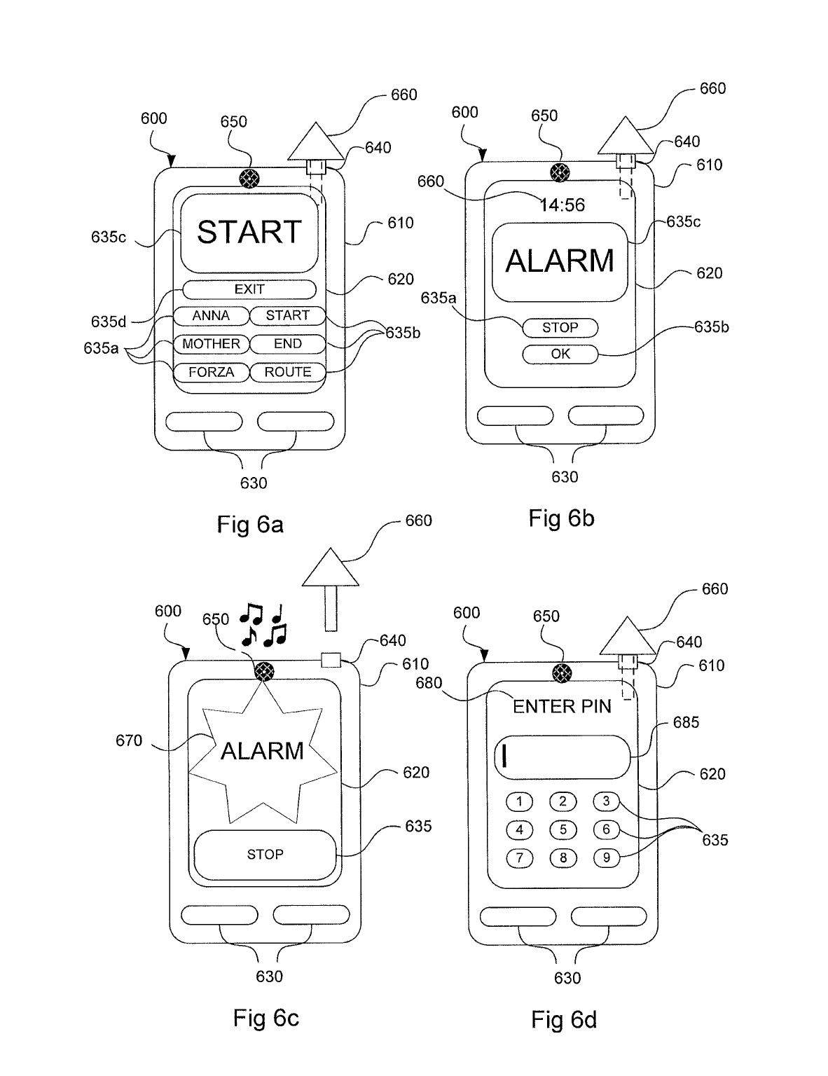

The safety application is now activated, i.e. operational and running, and in one embodiment a display image as shown in FIG. 6a is displayed on the display 620. The controller 210 is now configured to receive session setup data 420. The controller is configured to display the specified rescuers as virtual buttons or keys 635a. This allows the user to easily select which rescuers should be activated for the current session. In one embodiment all specified rescuers are selected by default. In one embodiment no specified rescuer is selected by default. The controller is further configured to display virtual keys 635b to allow the user to set a start and endpoint of the session. The controller is further configured to determine when the start point is reached and in response initiate the safety session, through a state transition 323 to state ARMED 330. The controller is further configured to determine when the end point is reached and if so terminate the safety session, through a state transition 336 to state AWAKE 320.

In an alternative or additional embodiment the controller 210 of a mobile device 100 is further configured to receive an END command when the safety application 500 is active and in response thereto deactivate the application 500 as indicated by the transition 326 in FIG. 3.

This allows a user to both start and/or end a safety session without much user input thereby making the safety arrangement easy to use.

In one embodiment as described above, where the controller is configured to receive an EXCUTE command to activate the safety application and an END command to deactivate the safety application, the mobile device enables the user to store the safety plug 660 in the socket 640. In such an embodiment, the user carries the safety plug 660 in the socket 640 and, as the user desires to activate the safety application 500, the user enters an EXECUTE command, possibly via a virtual key (not explicitly shown in FIG. 6, but referenced 130 in FIGS. 1a and 1b). The safety application 500 is thereby activated through the transition 313 and put in the AWAKE state 320. Should the controller detect that no safety plug 660 is inserted in the socket 640, the controller may cause a prompt or notification to be displayed or otherwise notified to the user that a safety plug 660 should be inserted. As the user desires to deactivate the safety application 650, the user enters an END command, possibly via a virtual key 635b and the controller deactivates the safety application 500 in response thereto through a transition 326 to the IDLE state 310. This manner of being able to activate and deactivate the safety application both through inserting the safety plug 660 and by entering a command is beneficial as it reduces the risk of the safety plug 660 becoming misplaced, dropped or otherwise lost. The user will also know where the safety plug is when having to activate the safety application quickly. Furthermore it facilitates the start point activation of the safety application. This manner solves the problem of losing the safety plug without having to provide a special receptacle for the safety plug, in which the safety plug may be carried when the application is to remain inactive. Such a receptacle both adds to the size and the cost of the mobile device. Two factors which are important in the mobile communication industry. Also, the manner taught herein provides for a less complicated activation of the safety application where the safety plug does not have to be moved back and forth when activating/deactivating the safety application.

In one embodiment the controller is configured to activate the safety application 500 in response to determining that a start point has been reached. A requisite is, as with the embodiments referred to above, that is has been detected that the plug 160 is received in the socket 140. Subsequently, if or when it is detected that the plug 160 is removed from the socket 140, the safety application will be caused to activate the alarm.

The activities taken to “activate the safety application” may include one or more of the following activities.

If the controller 210 detects that the safety application 500 is not currently loaded, the controller may load it from the memory 240 and thus bring it to the IDLE (background) state 310, the AWAKE (foreground) state 320, or even directly to the ARMED state 330.

If the controller 210 detects that the safety application 500 is in the IDLE (background) state 310, the controller may bring it (e.g. transition 313) to the AWAKE (foreground) state 320 where the safety application 500 is in control of the user interface 620, 630 of the mobile device, and/or the ARMED state 330.

If the controller 210 detects that the safety application 500 is in the AWAKE state, the safety application (500) may be brought (e.g. transition 323) to the ARMED state 330, in which it is configured to monitor removal of the plug 160 from the socket 140 and accordingly cause activation of the alarm (e.g. transition 333 to the FIRED state 340).

One advantageous action represented by “activate the safety application” is therefore to bring the safety application 500 to the ARMED state 330. This action enables for a fast and simple activation without the need for any additional input.

The controller may also be configured to determine that an end point has been reached, and accordingly deactivate the safety application 500. “Deactivate the safety application 500” may involve performing the reversal of any of the activities referred to above for activating the safety application.

In one embodiment the start and end points are time-specific. In one such embodiment the start point indicates at what time the session should start and/or the end point indicates at what time the session should end. In such an embodiment the start and end points are absolute and the controller determines that the start or end point has been reached when the start time and/or end time coincides with a current time, respectively.

In an alternative embodiment the start point may indicate in how long time the session will start, and/or the end point may indicate how long the session will last. In such an alternative embodiment, the start and/or end points are relative and the controller determines that the (start and/or) end point has been reached based on a lapsed time. In one embodiment the controller 210 is configured to set the start and/or end points to default values. In one such embodiment the default values are user selectable. In one such embodiment the default value for the start time indicates the current or present time. It should be noted that in one embodiment the start time may be absolute and the end time relative, and in another embodiment the start time may be relative and the end time absolute.

In one embodiment the start and end points are location-specific. In one such embodiment the start point indicates at what location the session should start and the end point indicates at what location the session should end. In such an embodiment the controller determines that the start or end point has been reached based a current position of the device. The current position of the device may be retrieved from a GPS module or through cellular triangulation or other location finding technique.

In one embodiment the controller 210 is configured to set the start and end points to be both time-specific and location-specific. In such an embodiment, a start point being both time-specific and location-specific is reached when the start location coincides with a current location and either when a lapsed time equals the relative start time or when the start time coincides with a current time, and vice versa for the end point.

In one embodiment the controller 210 is configured to set the start and end points to default values. In one such embodiment the default values are user selectable. In one such embodiment the default value for the start position indicates the current location.

In one embodiment the controller 210 is configured to display both time-specific and location-specific start and end points.

In one embodiment the start and/or end point is related to a particular sound indicating a risk. In one such embodiment the controller is configured to receive a sound through a microphone, compare it to a stored sound and if a match is determined, the controller activates the safety application. The comparison may be performed using fuzzy logic or other means also accepting sounds that are similar, but perhaps not an exact match. Such a sound may be an explosion, the sound of a crash, the sound of sirens, the sound of someone uttering threats or the sound of someone screaming for help.

In one embodiment the start and/or end point is related to a particular image or object in an image indicating a risk. In one such embodiment the controller is configured to receive an image or image stream, identify an object in the image or image stream, compare the object to a stored object(s) and if a match is determined, the controller activates the safety application. The comparison may be performed using fuzzy logic or other means also accepting objects that are similar to the stored object(s), but perhaps not an exact match. Such an object may be an explosion, a crash, someone screaming for help, someone carrying a weapon.

In one embodiment the controller 210 is configured to store preset session values in the safety application 500, where the preset session values represent a common route, for example a favourite running route, the route from work to home or other routes commonly taken by a user. The route may also be a working route, for example a watch route to be followed by security staff. The start and end points referred to above may then be points along the stored route, for instance the start and end points thereof. In one embodiment the controller is configured to display a favourite or default route (ROUTE) on the display 620. Also displayed is a virtual key 635c indicating that the session should start.

It should be noted that even though the description herein focuses on the use of virtual key it is highly possibly to implement the teachings herein with hardwired keys 630 or a combination thereof.

The controller 210 is further configured to detect an actuation of the virtual START key 635c. This initiates a safety session through a state transition 323 to the state 330 ARMED of FIG. 3, 425 of FIG. 4.

As already mentioned, in one embodiment the controller is configured to monitor the device's location and compare to pre-stored start positions. As a start position is reached the controller is configured to initiate the transition into the ARMED state 330. In such an embodiment the controller may further be configured to store a complete route. Such start points and/or routes may be pre-stored upon delivery of the device, downloaded to the device or set by a user or administrator.

In one embodiment the controller is configured to initiate the transition into the ARMED state 330 from either of the IDLE state 310 or the AWAKE state 320. The same automatic transition into the ARMED state 330 is, of course, possible both for time points and for location points. If the transition is made from the IDLE state the safety application is activated through the transition and armed at the same time. This enables the user to set up areas and/or times of particular risk and to have the safety application activated as such areas or times are reached or entered and possibly also arm the alarm automatically, thereby providing additional security without having to execute any time consuming actions.

The same automatic transition into the ARMED state 330 is, of course, possible for sound points and image points as well.

It is thus possible to activate the safety application either by a transition from the IDLE state 310 to the AWAKE state 320, illustrated by FIG. 6a, or through a transition from the IDLE state 310 directly to the ARMED state 330, illustrated by FIG. 6b, whereby the safety application is both armed and activated. This allows for a simple and quick activation and/or arming of the safety application.

In one embodiment the controller is configured to monitor the distance to or presence of a beacon, for example a Bluetooth beacon. Should the device 100 come within a preset distance to the beacon or within range of the beacon the controller is configured to initiate the transition into the ARMED state 330. Or, alternatively (possibly on a per beacon basis), should the device 100 come outside of a preset distance to the beacon or out of range of the beacon the controller is configured to initiate the transition into the ARMED state 330.

This allows for example security companies to set up watch routes for their personnel. This also allows parents to set up dangerous or high risk areas for their children.

In one embodiment the controller is configured to store at least one paired device and to monitor or sense the location of the paired device and when the paired device is within or outside a specific distance (for example 10m, 20 m, 50 m, 100 m or 500 m) from the mobile device 100 the controller is configured to initiate the transition into the ARMED state 330. This allows for parents to set up their children's mobile devices to arm should the child wander off away from the parent or guardian unintentionally. It also allows for a user to safeguard against a particular other person by setting up the device to arm should the other device come within the preset distance.

In one embodiment the controller is configured to send a notification message to one or more of the rescuers indicting that a session is starting. This enables the rescuers to be aware of the fact that the user is in a potentially dangerous situation and the rescuer is able to prepare for an incoming alarm, for example by making sure that the rescuer keeps his phone close by so as not to miss an alarm.

While in the ARMED state 330 the controller 210 is configured to display a display image such as in FIG. 6b. In one embodiment the controller is configured to display a virtual button for initiating an alarm 635c. The virtual alarm button 635c is preferably made large so that it is easy to press. A stop button 635a is alternatively also displayed and an OK button 635b is alternatively displayed. Furthermore optional data such as time left 660 may be displayed in one embodiment.

In one embodiment the controller 210 is configured to detect whether the STOP button 635a is actuated, and, if so, initiate a deactivation sequence 455-465.

In one embodiment the controller 210 is configured to detect whether the OK button 635b is actuated, and, if so, send a message to one or more of the specified rescuers. For example a text message “I am ok” could be sent to let the rescuers know that everything is still ok. This is advantageous during for example long sessions.

In one embodiment the controller 210 is configured to detect if the plug 160 is removed from the socket 140, 435, and, if so, initiate an alarm sequence 440.

In one embodiment the controller 210 is configured to monitor time and/or position 430 and determine whether a time limit or location limit is reached or surpassed, and, if so, initiate an alarm sequence 440. In one embodiment the controller 210 is configured to prompt the user whether the alarm should be activated or postponed. Should the controller not receive any instructions within a given preset time the alarm sequence is initiated 440. Should the controller receive instructions from the user relating to postponing the time or location limit the time or location limit is updated accordingly. In one embodiment the controller 210 is configured to send a notification message to one or more rescuers if a postponement of the session is effected informing the one or more rescuers about the extended safety session.

In one embodiment the controller 210 is further configured to monitor the location of the device 100 and if the location does not change within a preset time (for example 5 minutes) the user is prompted whether an alarm should be executed or not. If the controller does not receive any instructions to defer execution of the alarm sequence within a preset time (for example 30 seconds) the alarm sequence is executed. This allows a device according to herein to activate an alarm if a user is struck down or otherwise attacked without being able to activate the alarm. Initiating an alarm sequence 440 initiates a state transition 333 to the state ALARM 340 of FIG. 3.

In one embodiment the controller 210 is configured to defer initiating the alarm sequence until a preset time (for example 3, 5 or 10 seconds) has lapsed. This allows for a user to be able to reset the alarm before a rescuer is notified. This is beneficial in that rescuers will not be alarmed unnecessarily. In one such embodiment the controller 210 is configured to display and/or sound a prompting that the alarm sequence will be executed unless the controller receives a postponement. In one embodiment such a postponement is effected through a deactivation sequence 455-465. In one embodiment such a postponement is effected through actuation of a key.

In the ALARM state 340 the controller 210 is configured to display a display image such as in FIG. 6c. In one embodiment the controller is configured to display a virtual button for deactivating the alarm 635. The virtual stop button 635 is preferably made large so that it is easy to press. The controller 210 is further configured to contact the rescuers 445. In one embodiment the controller 210 is configured to contact all rescuers. In one embodiment the controller 210 is configured to contact one rescuer at a time. In one such embodiment the controller 210 is configured to contact the rescuers in order of priority. In one embodiment the controller 210 is configured to contact a lower priority rescuer if it is not possible to contact a higher priority rescuer.

In one embodiment the controller 210 is configured to contact a rescuer via a voice call. In one such embodiment the controller 210 is configured to play a pre-recorded or speech synthesized message to the rescuer upon call pick up. In one embodiment the controller 210 is configured to connect a voice call to allow the rescuer to communicate directly with the user.

In one embodiment the controller 210 is configured to contact a rescuer via a text message, such as a Short Message Service (SMS) message or a Media Message Service (MMS) message. In one such embodiment the controller 210 is configured to retrieve data pertaining to a current location and to attach the location data to the message to allow the rescuer to ascertain the user's location.

In one embodiment the controller 210 is configured to contact a rescuer via a pre-specified coded communication. Such a communication is in one embodiment a call to a call center wherein the controller is configured to sound a coded message using for example DTMF (Dual Tone Multiple-Frequency) tones. The coded message is arranged to carry information identifying the user and that an alarm has been activated. In one embodiment the controller 210 is configured to retrieve data pertaining to a current location and to attach the location data to the message to allow the rescuer to ascertain the user's location.

In one embodiment the controller 210 is configured to sound an audible alarm through the loudspeaker 650. The audible alarm can be an alarm tune, a spoken message or any combination thereof. In one embodiment the controller 210 is configured to show that an alarm is activated on the display through a visual notification 670. A noticeable alarm has the benefit that it may be deterrent to an assailant.

In one embodiment the controller 210 is configured to not sound off any alarm tone. A silent alarm has the benefit that it does not attract attention to the fact that an alarm is activated and this will potentially prevent an assailant from trying to turn off or deactivate the alarm preventing any rescuer from aiding the user.

In one embodiment the controller 210 is configured to initiate a locked state of the mobile device 100 rendering the mobile device 100 inoperable until a correct code has been received. This has the advantage of enabling a theft protection of the mobile device 100 as an inoperable device 100 is less attractive to thieves. In one embodiment the controller is further configured to initiate a tracking application. The tracking application is, in one embodiment, arranged to retrieve data identifying a location and forward said location data to a pre-specified contact, for example a security firm, the police or an insurance company. In one embodiment the controller 210 is configured to execute the tracking application repetitively.

The controller is configured to detect if a plug 160 is received 450 in the socket 140, and, if so, initiate a deactivation sequence 455-465. In one embodiment the controller is further configured to detect an actuation of the virtual STOP button 635 of FIG. 6c, step 450 of FIG. 4, and, if so, initiate a deactivation sequence 455-465.

The controller is configured, in one embodiment to display a display image such as in FIG. 6d while in the deactivation sequence. In one embodiment a prompt 680 for the user to input a PIN (Personal Identification Number) code is displayed 455. An input window 685 is also displayed along with virtual number buttons 635 so that the user can input his PIN. In one embodiment the code can be provided through other authorisation schemes such as reading and matching of biometric data (voice, finger print or retina scan). The deactivation code is received and checked to determine if it matches the stored code in step 460.

In one embodiment the controller 210 and safety application 500 are configured to store a deactivation code 530. The controller 210 is configured to receive a code candidate and to determine if the candidate code matches the stored deactivation code 530, and, if so, deactivate the alarm 465 and initiate a transition 346 to the ARMED state 330. The controller is configured to send out a cancellation message to the rescuers when the alarm is deactivated. In one embodiment the controller 210 is configured to additionally determine whether the code candidate is received within a pre-specified time limit (for example 30 seconds), and, if the code is not received within the time limit the controller is configured to re-activate the alarm as the time limit expires.

In one embodiment the controller 210 and safety application 500 are configured to store a second deactivation code 540. The controller 210 is configured to receive a code candidate and to determine if the candidate code matches the stored second code 530, and, if so, display the display image of FIG. 6a or alternatively or additionally display a notification that the alarm has been cancelled (not shown) and turn off any audible alarms. However, the alarm will still be active as described above. This allows for a silent alarm to be sounded which find uses in situations where a user is under duress from an assailant to turn off the alarm.

In one embodiment the controller is arranged to detect an actuation of the virtual STOP button 635, FIG. 6b, while in the ARMED state 330, and, in response thereto prompt the user for a code by displaying a display image such as shown in FIG. 6d. The controller 210 is further configured to receive a code and to determine if the code matches a stored code 530, and, if so, initiate a transition 336 to the AWAKE state 320. This allows for making sure that the ending of an alarm readiness is purposeful and executed by the user.

In one embodiment the controller is arranged to detect an actuation of the virtual EXIT button 635d, FIG. 6a, while in the AWAKE state 320, and, in response thereto initiate a transition 326 to the IDLE state 310. Alternatively the controller is also configured to terminate the execution of the safety application 500 thus effectively ending the safety session.

In one embodiment the controller is arranged to detect a removal of the plug 160, while in the AWAKE state 320, and, in response thereto initiate a transition 326 to the IDLE state 310.

A user can thus easily deactivate the safety session by removing the plug 160.

As has been disclosed in the above, the mobile device may alternatively be enabled to deactivate the safety application by receiving an END command.

It should be noted that the use of time and or locations to specify boundaries for the safety application is optional and in one embodiment the controller 210 is configured to operate or execute the session without any specified setup data relating to time or location. In such an embodiment the alarm will be active as long as the safety application 500 is activated and the plug 160 is inserted in the socket 140.

In one embodiment the mobile device 100 and plug 160 arrangement arranged to be used as a door alarm or purse theft alarm arrangement. In one such embodiment the plug 160 is attached to a string or other connector for connecting to either the door or the door frame, alternatively a loop to be carried around a wrist or such while the mobile device 100 is carried in a purse.

FIG. 7 shows a schematic view of a plug 700 according to the teachings herein. The plug 700 comprises a head 710 and a protrusion 720. In this embodiment the plug 700 is a TRS plug and the protrusion 720 comprises a tip portion 730, a ring portion 735 and a sleeve portion 740 (FIG. 7a).

It should be noted that many different shapes of the head 710 are possible and is a matter of design choice.

In one embodiment (FIG. 7b) the head 710 is arranged with a light, for example a LED (Light Emitting Diode) 745. In one embodiment the controller is arranged to activate the LED 745 when the alarm is activated (state 340) and/or armed (330). This allows a user to quickly determine what the status of the safety session is.

In one embodiment the socket 140 is the audio socket of the mobile device 100. In one such embodiment the controller 210 is configured to detect whether a plug received in the socket 140 is an audio plug or a safety plug 160. To enable this, the plug is arranged with an identification module 750 (FIG. 7c).

In one embodiment the identification module 750 is arranged as an analogue electronic filter arranged to receive a signal, modulate it and return it as an identification response. In one such embodiment the controller is configured to send an electronic signal or pulse through the socket 140, detect the identification response received and to determine if the identification response is correct. If so, the controller determines that a safety plug is received.

In one such embodiment each or a group of safety plugs 160 are arranged with unique identification modules. This enables the controller to determine that the correct safety plug 160 is received. In one such embodiment the controller is configured to send an electronic signal or pulse through the socket 140, measure the impedance over the plug and based on the measured impedance determine if a safety plug 160 or a head phone is received in the socket 140. In such an embodiment the plug 700 is arranged to have a (substantially) different impedance compared to head phones. In one embodiment the identification module 750 is arranged as an analogue electronic filter arranged to receive a signal, modulate it and return it as an identification response.

In one embodiment the identification module 750 is arranged as a digital electronic circuit arranged to receive a signal, modulate it and return it as an identification response. In one such embodiment the controller is configured to send an electronic signal or pulse through the socket 140, detect the identification response received and to determine if the identification response is correct. If so, the controller determines that a safety plug is received. In one such embodiment each or a group of safety plugs 160 are arranged with unique identification modules. This enables the controller to determine that the correct safety plug 160 is received. A digital circuit can also be utilized to carry additional data pertaining to personal preferences, which alarm center to contact, contact details for the rescuers. A digital filter also allows for a more precise identification of a large group of different safety plugs having different identities.

This prevents the alarm from being deactivated with any plug that fits the socket 140.

In one embodiment the socket 140 is a USB (Universal Serial Bus) port. This allows for more intelligent safety plugs, which are able to carry advanced instructions, restrictions, and/or personal settings. For example, in one embodiment the safety plug 700 carries a GPS unit which enables the mobile device 100 to retrieve position data identifying a location.

In an embodiment where the plug 700 is arranged with a digital circuit the plug is arranged to register which state the safety application is currently in. The safety pug 700 is further configured to receive a request for a state status and in response thereto send a response identifying which state the safety application is currently in.

In one embodiment (FIG. 7d) the safety plug is arranged with a biased switch 755. The controller 210 and/or the electronic circuit is/are configured to detect whether the switch is deactivated while in the ARMED state 330, and, if so, initiate or cause the controller 210 to initiate a transition to the ALARM state 340. This enables the safety plug to function as a dead man's grip which allows for quick and reliable alarming as the user only has to let go of the safety plug to activate the alarm. In one such embodiment the controller is configured to determine whether the switch is activated again within a time limit (for example 5 seconds), and, if so, deter from activating the alarm.

In one embodiment (FIG. 7e) the plug 700 is arranged with a socket 760 adapted to receive a further plug. In one embodiment the socket is an audio socket and the further plug is an audio plug, for example a TRS socket/plug pair. In such an embodiment the socket 760 is arranged with a tip-receiving portion 763, a ring-receiving portion 766 and a sleeve-receiving portion 769 arranged to be connected to the tip portion 730, ring portion 735 and sleeve portion 740 respectively. This allows for a safety plug 160 to occupy an audio socket 140 while still allowing a head set or other audio equipment to be connected to the mobile device 100.

In on embodiment the safety plug 700 is also configured with a user interface (not shown) wherein the safety plug is arranged to receive a key actuation from said user interface and to forward said key actuation or a command associated with the key actuation to an audio equipment connected to the socket 760. This allows for utilizing the safety plug as a remote control to an audio device connected through the socket 760.

It should be noted that the embodiments disclosed with reference to FIG. 7 may be combined in any order.

In one embodiment the safety plug 160 is arranged to have a specific and high weight. The weight should be such that if the safety plug 160 is subjected to a sudden deceleration the safety plug 160 will be removed from the socket 140. The weight of the safety plug is thus dependant on the structure of the socket 140 and how it interacts with the plug 160 as well as the rate of deceleration that should allow the safety plug 160 to be removed.

If such a mobile device and a safety plug arrangement is arranged in an automobile or other vehicle it may be utilized as a collision alarm that is activated through the high deceleration that follows a collision.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

One benefit of the teachings herein is that a safety device is achieved without structural modifications to an existing mobile phone. A phone can easily be loaded with the safety application and act as a safety device in co-operation with a safety plug. This provides a safety device that is easy to carry, does not take any extra space (as a phone would be carried anyway) and which is easy to activate and also deactivate. The safety arrangement is also highly versatile and adaptable to a user's preferences.

The invention has mainly been described above with reference to a few embodiments. However, as is readily appreciated by a person skilled in the art, other embodiments than the ones disclosed above are equally possible within the scope of the invention, as defined by the appended patent claims.

Further aspects of the invention are described in the following ordered clauses.

A. A mobile device (100) comprising a memory (240), a socket (140) and a controller (210), wherein said socket (140) is configured to receive a plug (160, 700), and wherein said controller (210) is configured to:

detect that a plug (160, 700) is received in the socket (140);

receive an execute command;

activate a safety application (500); and

detect that a plug (160, 700) is removed from the socket (140), and, in response thereto, activate an alarm.

B. The mobile device (100) according to clause A, wherein said controller (210) is further configured to:

receive a start command and in response thereto arm said safety application (500).

C. The mobile device (100) according to clause A or B, wherein said controller (210) is further configured to receive an end command and in response thereto deactivate said safety application (500).

D. The mobile device (100) according to clause C, wherein said controller (210) is further configured to receive a code and in response thereto disarm said safety application (500).

E. A method for activating an alarm for use in a mobile device (100), said method comprising:

detecting that a plug (160, 700) is received in the socket (140);

receiving an execute command;

activating a safety application (500); and

detecting that a plug (160, 700) is removed from the socket (140), and, in response thereto, activating an alarm.

F. A computer readable storage medium encoded with instructions that, when executed on a processor, perform the method according to clause E.

1. A mobile device comprising:
a memory;
a socket; and
a controller operatively coupled to the memory and the socket;
wherein the socket is configured to receive a plug; and wherein the controller is configured to
detect that the plug is received in the socket,
determine that a start point has been reached and in response thereto activate a safety application, and
detect that the plug is removed from the socket, and, in response thereto, cause the safety application to activate an alarm.

2. The mobile device according to claim 1, wherein the controller is configured to activate the safety application, in response to having determined that a start point has been reached, by one or more of the following activities:
loading the safety application from the memory;
bringing the safety application to a foreground state where the safety application is in control of a user interface of the mobile device; and
bringing the safety application to an armed state configured to monitor removal of the plug from the socket and accordingly cause activation of the alarm.

3. The mobile device according to claim 1, wherein the controller is configured to determine that an end point has been reached and in response thereto deactivate the safety application.

4. The mobile device according to claim 3, wherein the start point and/or the end point is time-specific, specifying a start time and/or an end time, respectively, and
wherein the start point and/or the end point has been reached when the start time and/or the end time coincides with a current time.

5. The mobile device according to claim 3, wherein the start point and/or the end point is time-specific, specifying a relative start time and/or a relative end time, respectively, and
wherein the start point and/or the end point is reached when a lapsed time equals the relative start time and/or the relative end time.

6. The mobile device according to claim 3, wherein the start point and/or the end point is location-specific, specifying a start position and/or an end position, respectively, and
wherein the start point and/or the end point is reached when the start position and/or the end position coincides with a current position.

7. The mobile device according to claim 3, wherein the start point and/or the end point is both time-specific and location-specific, and
wherein the start point and/or the end point is reached when a start location and/or an end location coincides with a current location, and either when a lapsed time equals a relative start time and/or a relative end time or when a start time and/or an end time coincides with a current time.

8. The mobile device according to claim 6, wherein the controller is configured to store a route, and
wherein the start point is a start point of the stored route.

9. The mobile device according to claim 1, wherein the controller is configured to:
detect that the plug is received in the socket while the alarm is active, and, in response thereto deactivate the alarm.

10. The mobile device according to claim 1, wherein the controller is configured to determine whether the plug is received a new within a time-limit after removal from the socket, and, if so deactivate the alarm.

11. The mobile device according to claim 1, wherein the controller is configured to store at least one pre-specified contact and to contact at least one of the pre-specified contacts when activating the alarm.

12. The mobile device according to claim 1, wherein the controller is configured to:
receive a candidate code;
determine whether the candidate code matches a stored code, and,
if so, deactivate the alarm.

13. The mobile device according to claim 12, wherein the controller is configured to determine whether the candidate code is received within a time-limit, and, if so, deactivate the alarm.

14. The mobile device according to claim 12, wherein the controller is configured to:
store a second code;
determine whether the candidate code matches the stored second code, and,
if so, execute the alarm as a silent alarm.

15. The mobile device according to claim 1, wherein the controller is configured to send a notification to at least one pre-specified contact informing the contact that a safety session is activated.

16. The mobile device according to claim 1, wherein the controller is configured to retrieve data pertaining to a current location and to provide the current location to at least one pre-specified contact.

17. A safety arrangement comprising:
a mobile device according to claim 1; and
a plug arranged to co-operate with the mobile device.

18. A method for activating an alarm for use in a mobile device, the method comprising:
detecting that a plug is received in a socket;
determining that a start point has been reached and in response thereto activating a safety application; and
detecting that the plug is removed from the socket, and, in response thereto, causing the safety application to activate an alarm.

19. A non-transitory computer readable storage medium encoded with instructions that, when executed on a processor, perform the method according to claim 18.
